(19) United States
(12) Patent Application Publication
(10) Pub. No.: US 2008/0041533 A1
(43) Pub. Date: Feb. 21, 2008

(54) Blinds with integrated lighting system

(76) Inventor: Albert William Ziegler, Mahopac, NY (US)

Correspondence Address: EDWIN TARVER, 16830 Ventura Blvd., SUITE 360, Encino, CA, 91436, US

(21) Appl. No.: 11/506,616

(22) Filed: Aug. 17, 2006

(51) Int. Cl. G08B 13/08

(52) U.S. Cl. 160/10

(57) ABSTRACT

An illuminating blind system comprising a plurality of slats, wherein each slat is associated with a light emitting source associated with a controller. When activated by the controller, visual patterns are created on the surfaces of the slats, based on the arrangement of the light emitting sources in relation to the position of the slats. The controller further comprises a clock to set automatic activation times for the plurality of light emitting sources. The light emitting sources are capable of producing single or multiple colors and a variety of brightness levels.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to window blinds, and more particularly to blinds integrated with a lighting system for creating various visual patterns on the surfaces of slats.

Window blinds are generally used to reduce sunlight or hide interiors from view. Blinds typically include a plurality of horizontal or vertical slats that can be rotated to allow or limit light entry. The slats are connected, and can be pulled up or sideways depending on their orientation. They may have decorative designs on the surfaces of the slats.

Several blinds with decorative features have been developed in the art. For example, U.S. Pat. No. 6,877,548 to Chartier discloses an indirect lighting system for vertical blinds and the like. The lighting system comprises an elongated housing or reflector that is to be mounted on a head rail of a vertical blind or the like. A light source is centrally disposed within the housing or reflector for illuminating the surface of the blind. In some disclosed embodiments, the housing is mounted in a stationary position, and in others the reflector rotates to control the direction in which the light shines.

U.S. Pub. No. 20050178511 to Sala discloses a window shade that includes a translucent shade material to provide shade from light, a panel located over the shade material, and suction cups for detachably attaching the sheet of the shade material to a window. The panel includes an electrically powered motor, light-emitting diodes and a speaker for producing motion, light and/or sound.

Int'l Pat. No. JP2001082058 to Yano Masaru discloses a blind device comprising a plurality of horizontal slats. Each slat includes three layers, namely, a top laminated solar battery layer, a middle secondary battery layer and a bottom luminous surface layer. When the solar battery layer forms an angle so as to face a window, the luminous surface layer faces an indoor side to receive incident solar light onto the solar battery layer. The incident sun light is converted into electric energy by the solar battery layer, to store electricity in the middle secondary battery layer. As a switch is turned on, the electrical energy stored is supplied to the luminous surface layer, which then emits light to irradiate indoors. The layered structure of the slats of this device differs from the present invention in the structure of the slats, which house a plurality of light emitting sources.

It is an object of the present invention to provide blinds with illuminating features using a plurality of light emitting sources such as light emitting diodes.

A further object of the present invention is to provide blinds with illuminating features, which include a plurality of light-emitting sources housed in the slats.

Finally, it is an object of the present invention to provide blinds with illuminating features, which create visual patterns on the surfaces of the slats by manual or automatic activation. These and other objects of the present invention will become better understood with reference to the appended Summary, Description, and Claims.

### SUMMARY

The present invention is an illuminating blind device that includes a plurality of slats, a plurality of light emitting sources and a controller. The light emitting sources comprise light emitting diodes (LEDs) and other devices associated with each of the slats, including organic light emitting diodes (OLEDs). The controller is associated with the plurality of light emitting sources. The light emitted from the light emitting sources comprises different colors and brightness, and the light emitting sources are arranged so as to produce patterns on the surfaces of the slats when activated by the controller. In one embodiment, the light emitting sources are arranged to produce an artificial sunshine pattern. The controller also includes a digital clock to set the time for automatically activating the light emitting sources.

### BRIEF DESCRIPTION OF THE FIGURES

FIG. 1 is a first embodiment of the blind system in accordance with the present invention, wherein light emitting diodes are incorporated into one of the slats of the blinds.

FIG. 2 is an alternate embodiment of the blind system in accordance with the present invention, wherein an electroluminescent wire is incorporated into one of the slats of the blinds.

FIG. 3 is a further embodiment of the blind system in accordance with the present invention, wherein a light emitting source is disposed between a top layer and a bottom layer of one of the slats of the blinds.

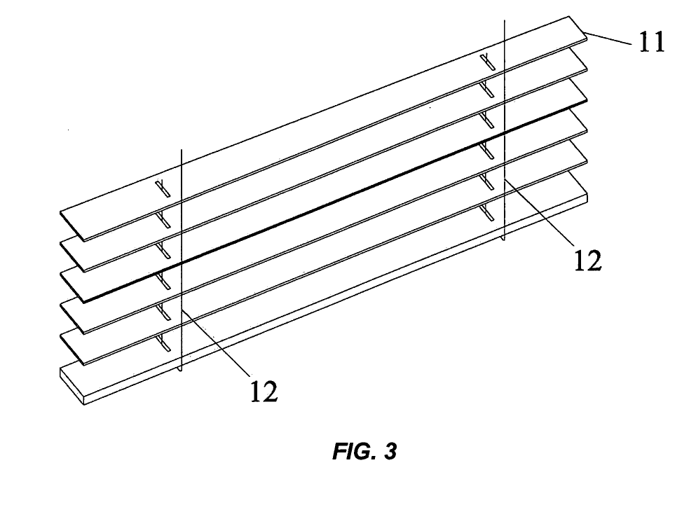

### FIGURES—REFERENCE NUMERALS

10 . . . Blind System of the Present Invention
11 . . . Slat
12 . . . Cord
13 . . . Control Member
14 . . . Light-emitting Diode
15 . . . Wiring
16 . . . Alternate Embodiment of the Blind System
17 . . . Electroluminescent Wire

### DETAILED DESCRIPTION

The present invention is an illuminating blind device. The device comprises a plurality of slats, a plurality of light emitting sources and a controller associated with the light emitting sources. The slats can either be horizontal or vertical and can be rotated between open and closed positions. Each slat houses a plurality of light emitting sources. Each light emitting source is capable of producing a single color and brightness or multiple colors and brightness.

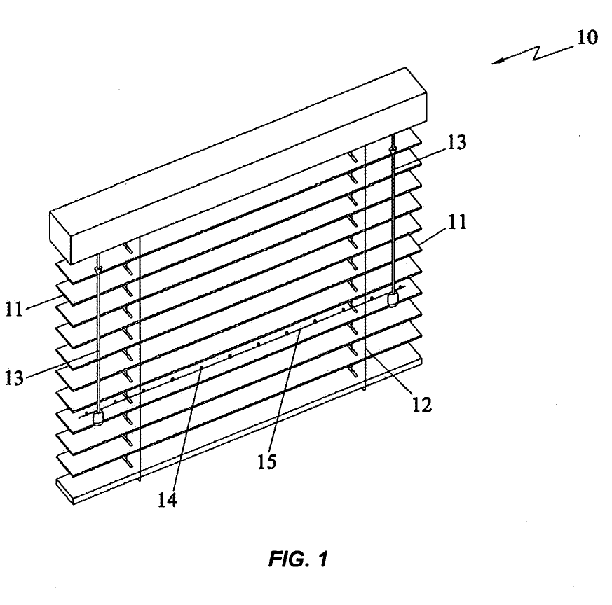

Referring to FIG. 1, in a preferred embodiment, the horizontal slats 11 are connected by cords 12 and a control member 13 is associated with the cords to rotate and move the slats 11 between horizontal and vertical orientations. A plurality of light emitting diodes (LED's) 14 are incorporated in the slats 11 of the device 10. The wiring 15 required to connect the LED's 14 is integrated into the cords 12. Alternatively, the wiring itself can be use as the cords 12 that connect the slats 11. The LED's are activated through a controller associated with the wiring 15. In one embodiment, the controller is housed in the control member 13 and includes a digital clock, which can be used to automatically control the LED's 14 according to a predefined schedule. Additionally, a switch (not shown) on the control member or a remote control means can be used to activate the LED's. In an alternate embodiment, organic light emitting diodes (OLEDs) may be used in connection with or in place of conventional LEDs.

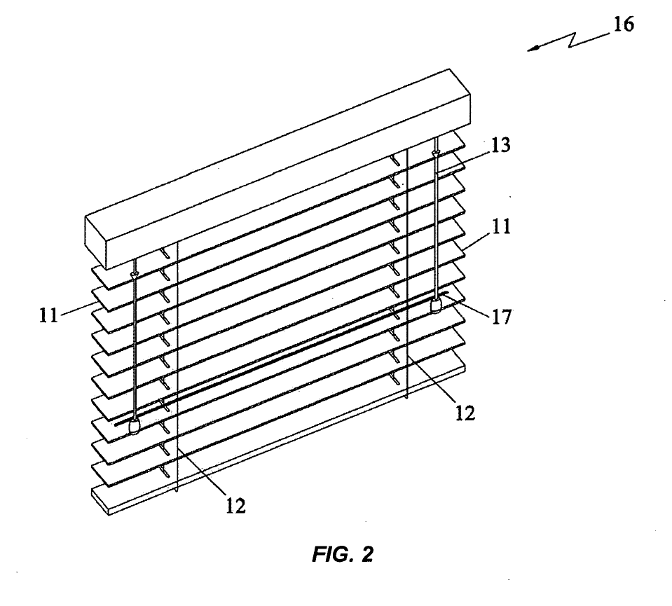

Referring to FIG. 2, a second preferred embodiment of the blind system 16 is similar to the previous embodiment, except that the LED's are replaced by electroluminescent wire or dimmable neon 17. The wire or neon 17 is incorporated into the slats 11. In another preferred embodiment (not shown), the wire or neon 17 is disposed at the rear of the slats and is hidden from view when the blinds are oriented so as to block the view from a window.

In still another embodiment, the slats are coated with materials that emit light by using captured solar energy. Batteries store solar energy during daylight hours. Similar to the two previous embodiments, the controller containing a digital clock, and the switch or remote control means for operating the controller are incorporated into the blind system.

The light emitting sources are arranged so that when they are activated, predetermined visual patterns are created on the surfaces of the slats, generating a predetermined pattern across the surface of the blinds. For example, a plurality of bright yellow and orange LED's may be selected to create the illusion of sunshine entering from the exterior of a window on the surfaces of the slats by allowing slats to reflect indirect light.

Where light emitting sources capable of producing multiple colors are used, the controller may include settings to change the colors of the lights for creating a variety of patterns on the surfaces of the slats. Settings for selecting the intensity of the light may also be included, for example low light and night light settings. These settings can be selected by switches on the connecting member or through a remote control means. The light emitting sources can also be associated with a computer including software applications for creating specific patterns on the surfaces of the slats.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A blind system with illuminating features and a plurality of slats comprising;
a. one or more light emitting sources associated with each of the slats, wherein each light emitting source is capable of producing a single or multiple colors and brightness;
b. the plurality of light emitting sources arranged so that when activated, light patterns are created across the surface of the blind system; and
c. a controller associated with the plurality of light emitting sources, including an activating means to activate the plurality of light emitting sources.

2. The blind system of claim 1, wherein the controller further comprises timing means for automatically activating the plurality of light emitting sources.

3. The blind system of claim 2, wherein the controller further comprises a clock associated with the timing means.

4. The blind system of claim 1, wherein the activation means comprises a remote control activation means.

5. The blind system of claim 1, wherein the plurality of light emitting sources comprise light emitting diodes; including LEDs, and organic light emitting diodes (OLEDs).

6. The blind system of claim 1, wherein the plurality of light emitting sources comprises dimmable neon

7. The blind system of claim 1, wherein the plurality of light emitting sources comprises fiber optics.

8. The blind system of claim 1, wherein the plurality of light emitting sources comprises electroluminescent wire.

9. The blind system of claim 1, wherein a plurality of light emitting sources capable of emitting a variety of colors and brightness are incorporated into the slats of the illuminated blind system.

10. The blind system of claim 9, wherein wiring connects the plurality of light emitting sources and is integrated into the cords that connect the slats

11. The blind system of claim 9, wherein the controller is housed in a member used to control the movement of the slats.

12. The blind system of claim 1, wherein the plurality of light emitting sources are arranged so as to create a pattern

13. The blind system of claim 12, wherein the plurality of light emitting sources are arranged so as to create the illusion of external sunshine on the surfaces of the slats.

14. The blind system of claim 1, wherein the controller includes settings for creating one or more patterns on the surfaces of the slats by changing the nature of the light emitted from the plurality of light emitting sources.

15. The blind system of claim 1, wherein the light emitting sources are capable of producing a variety of colors and brightness on individual slats.

16. The blind system of claim 15, wherein the light emitting sources are controlled by a computer including software that causes the light emitting sources to create patterns of light on the blind system.

17. The blind system of claim 1, wherein the light emitting sources emit light from the sides of the slats of the blind system

18. The blind system of claim 17, wherein the light emitting sources emit light from the sides of the slats closest to the window.

19. The blind system of claim 17, wherein the light emitting sources emit light from the sides of the slats farthest from the window.

20. The blind system of claim 17, wherein the light emitting sources emit light from the short sides of the slats at the sides of the blind system.

21. The blind system of claim 1, wherein the light emitting sources are disposed in the slats, sandwiched between top and bottom surfaces of the slats.

22. The blind system of claim 21, wherein one or more sides of the slats illuminate.

23. The blind system of claim 1, wherein the light emitting sources are affixed to one or more surfaces of the slats.
